(19) United States
(12) Patent Application Publication
(10) Pub. No.: US 2024/0233137 A9
(43) Pub. Date: Jul. 11, 2024

(54) A DATA-GENERATING PROCEDURE FROM RAW TRACKING INPUTS

(71) Applicant: CALIPSA LIMITED, LONDON (GB)

(72) Inventors: SIDDHARTH AGRAWAL, LONDON (GB); ASHWIN D'CRUZ, LONDON (GB); CHRIS TEGHO, LONDON (GB); DAVID HALL, LONDON (GB); BORIS PLOIX, CAMBRIDGE, MA (US)

(21) Appl. No.: 18/275,668

(22) PCT Filed: Feb. 11, 2022
(86) PCT No.: PCT/GB2022/050378

§ 371 Date: Aug. 3, 2023

(51) Int. Cl. G06T 7/20; G06T 7/62; G06V 10/25; G06V 10/74; G06V 20/70

(52) U.S. Cl. CPC G06T 7/20; G06T 7/62; G06V 10/25; G06V 10/761; G06V 20/70; G06V 2201/07

(57) ABSTRACT

The present invention relates to identifying and/or generating high quality training data. More particularly, the present invention relates to determining a subset of images from a dataset that can be used as substantially high quality training data for the training of movement detection systems.

Aspects and/or embodiments seek to provide a system and/or method of generating substantially high quality training data for a security event detection method and/or system using video data from surveillance cameras as input data.

### FIELD

The present invention relates to identifying and/or generating high quality training data. More particularly, the present invention relates to determining a subset of images from a dataset that can be used as substantially high quality training data for the training of movement detection systems.

### BACKGROUND

Video surveillance is used on a large scale for security purposes, and can be monitored by both security personnel and automated systems.

Due to the maturity of the technologies used, and in consequence the relatively low cost of installing video surveillance equipment an increasing number of cameras are typically installed and ever increasing amounts of video data are therefore being generated for security purposes.

At the same time, the trend is typically to use fewer security personnel in order to reduce personnel costs associated with providing security.

It is generally recognised that security personnel are typically poor at monitoring large numbers of video feeds, i.e., large numbers of separate cameras consistently over long periods of time, in order to detect potential security threats.

As a result, automated systems are increasingly desired to performed automated monitoring of the video data acquired using video surveillance systems, both to decrease personnel costs and increase accuracy of detecting potential security threats.

To provide accurate automated systems for monitoring video surveillance footage, sufficient and high quality training data is typically required. High quality training data would typically include relevant footage of security threats that has accurate time stamp information and accurate labelling. However, it is generally difficult for humans to accurately determine when an alert for a potential security threat should be triggered when performing a manual review of security footage, and thus it is hard for humans to accurately label the footage to create high quality training data, especially when there are multiple moving objects/personnel in the surveillance data and each of these objects/personnel might be perceived by the security system as a threat for which an alert should be generated.

Thus there is a need for substantially high quality training data for use with security systems for surveillance using security camera equipment.

### SUMMARY OF INVENTION

Aspects and/or embodiments seek to provide a system and/or method of generating substantially high quality training data for a security event detection method and/or system using video data from surveillance cameras as input data.

According to a first aspect, there is provided a computer-implemented method of generating training data for one or more computer models, the method comprising: receiving a plurality of image data, wherein the image data comprises two or more sequential images; wherein the image data comprises one or more objects determined in each of the plurality of images and wherein the image data comprises a bounding box identifying each of the one or more objects in each of the plurality of images and wherein the image data comprises one or more common objects identified in two or more sequential images; determining a correlation between the identified one or more common objects detected in two or more sequential images using the bounding boxes for each of the one or more common objects; generating a score indicating movement of the identified one or more common objects detected in two or more sequential images based on the determined correlation; and outputting the score associated to each of the identified one or more common objects.

Determining a score indicating movement of identified objects between sequential images can allow for pairs of images to be identified and/or labelled in which sufficient movement is shown that is intended to trigger an alarm in a security system using a model trained on data showing desired movement between frames.

Optionally, generating the bounding box for each of the one or more objects comprises using one or more trained computer model.

Generating a bounding box around a detected object can allow for a standardised way to determine movement of the same object between sequential frames, as the bounding box will be substantially the same size should the object not be moving towards or away from the image capture device, thus provides a way to determine the movement of an object between frames of video without requiring more complex segmentation of objects within each frame.

Optionally, generating the bounding box for each of the one or more objects comprises manual labelling by one or more human users.

Bounding boxes can be added manually, or edited manually, to images by human users to ensure quality of training data. This can occur alongside automated generation of bounding boxes.

Optionally, the method further comprises determining at least two sequential images based on metadata associated with the image data. Optionally, the metadata associated with the image data comprises timestamp data.

Typically, video data comprises metadata that can be used to identify the order of the frames within the video. Sometimes frames need to be generated from the video data due to the encoding of the video data. Sequential frames can typically be identified, using the metadata that is used when displaying videos to display the correct sequence of images, and if needed the sequential frames extracted and/or re-generated from the video.

Optionally, the method further comprises determining at least two sequential images based on similarities of determined one or more objects in at least two sequential images.

Sometimes the sequential images can be images that are not strictly sequential (i.e. substantially sequential) but a number of frames apart in the sequence forming the video. If using sequential or substantially sequential images as the pair of images being considered, the similarities in the images can be determined to make the choice of which pairs of images to use.

Optionally, determining a correlation between the identified one or more common objects comprises comparing at least two corners of a bounding box of one or more common objects in a first image to at least two corresponding corners of a bounding box for the same one or more common objects in a sequential image.

Comparing the movement between image frames of a video of an object common to both frames using at least two corners of a bounding box associated with the common object can allow for a more robust movement score to be generated.

Optionally, determining a correlation between the identified one or more common objects comprises determining whether the bounding boxes for the one or more common objects in two or more sequential images have deviated in size.

By determining whether the bounding boxes have changed in size/area, it can be determined whether the object has moved towards or away from the image sensor and movement can be determined in multiple axes.

Optionally, determining a correlation between the identified one or more common objects comprises determining whether the bounding boxes for the one or more common objects in two or more sequential images have deviated in location. Optionally, the deviation in location corresponds to a co-ordinate grid of the image data or based on an XY axis of the image data. Optionally, the deviation comprises a predetermined threshold of pixels. Optionally, generating a score is based on the deviation between at least two corners of a bounding box of one or more common objects in a first image and at least two corresponding corners of a bounding box for the same one or more common objects in a sequential image.

Determining whether an object has moved can be performed by determining whether the object has changed location rather than the camera having moved and the object has stayed in one physical place but moved within the image frame. Thus a co-ordinate in the environment and/or within the image frame can be determined for the object in one or more image frames. It is possible to use a measurement scale that maps to the environment or a measurement scale that uses the pixels within each image. The threshold for determining whether there is sufficient movement for the data to be considered training data can be determined by a scale relevant to the physical environment or the pixels in the image.

Optionally, generating a score is based on the size of the bounding box relative to the image frame. Optionally, generating a score is based on an average deviation of at least two corners of a bounding box of one or more common objects in a first image and at least two corresponding corners of a bounding box for the same one or more common objects in a sequential image. Optionally, the average deviation comprises generating and comparing a deviation in the diagonal length of a bounding box of one or more common objects in the first image and the diagonal length of a bounding box of one or more common objects in the sequential image.

Generating a movement score can be done by taking the average of the pixels/distance moved by the object between frames across a plurality of corners of the bounding box.

Optionally, outputting the score comprises a predetermined threshold. Optionally, the method further comprises outputting one or more pairs of bounding boxes for one or more common objects.

Optionally, the one or more objects determined in each of the plurality of images are determined by any or any combination of: manually identifying objects in each image; using an object detector to identify and/or localise and/or predict objects of interest in each image and/or a portion of each image.

Optionally, the bounding box for each of the one or more objects in each of the plurality of images is generated by any or any combination of: manually applying a bounding box to each image; applying a bounding box around each detected object predicted and/or localised and/or identified by an object detector.

Optionally, the one or more common objects in two or more sequential images are identified by any or any combination of: manually identifying common objects between each of the images; matching objected detected in multiple images and applying a link between detected objects in different images.

Objects can be manually identified by humans or automatically detected using object detector computer models, which can be trained machine learning models. This process of identifying and labelling objects of interest within image frames enables the same object to be tracked across sequential images frames. When using machine learning models, the images can be processed patch-wise, and determinations can be made on whether each patch comprises an object of interest. In this way, the models can determine the identify and location of an object of interest. The machine learning models can be trained to detect one or more sets of object categories such as cars, people, street furniture, etc.

The score and/or metadata and/or source data can be output by the method for either or both the data selected as training data and the data not selected as training data.

According to a further aspect, there is provided a computer program comprising instructions which, when the program is executed by a computer, cause the computer to carry out the method of any aspect and/or embodiment.

According to a further aspect, there is provided a computer-readable medium comprising instructions which, when executed by a computer, cause the computer to carry out the method of any aspect and/or embodiment.

### BRIEF DESCRIPTION OF DRAWINGS

Embodiments will now be described, by way of example only and with reference to the accompanying drawings having like-reference numerals, in which:

FIG. 1 shows an overview of a positive training data creation process according to an embodiment;

FIG. 2 shows an example of pairing images for the training data creation process according to an embodiment;

FIG. 3 shows an example of processing input image data according to an embodiment;

FIG. 4 shows an example of objects shown in sequential image frames according to an embodiment;

FIG. 5 shows an example of objects shown in sequential image frames with bounding boxes according to an embodiment;

FIG. 6 shows an example of bounding boxes representing detected objects according to an embodiment;

FIG. 7 shows an example of overlaid sequential image frames depicting moving objects and constant objects according to an embodiment;

FIG. 8 shows an example of an additional sequential image frame with detected objects in bounding boxes according to an embodiment;

FIG. 9 shows an example of three overlaid sequential image frames depicting moving objects and constant objects according to an embodiment;

FIG. 10 shows and example of objects shown in sequential image frames according to an embodiment;

FIG. 11 shows an example of bounding boxes representing detected objects according to an embodiment; and

FIG. 12 shows an example of three overlaid sequential image frames depicting moving objects and constant objects according to an embodiment.

### SPECIFIC DESCRIPTION

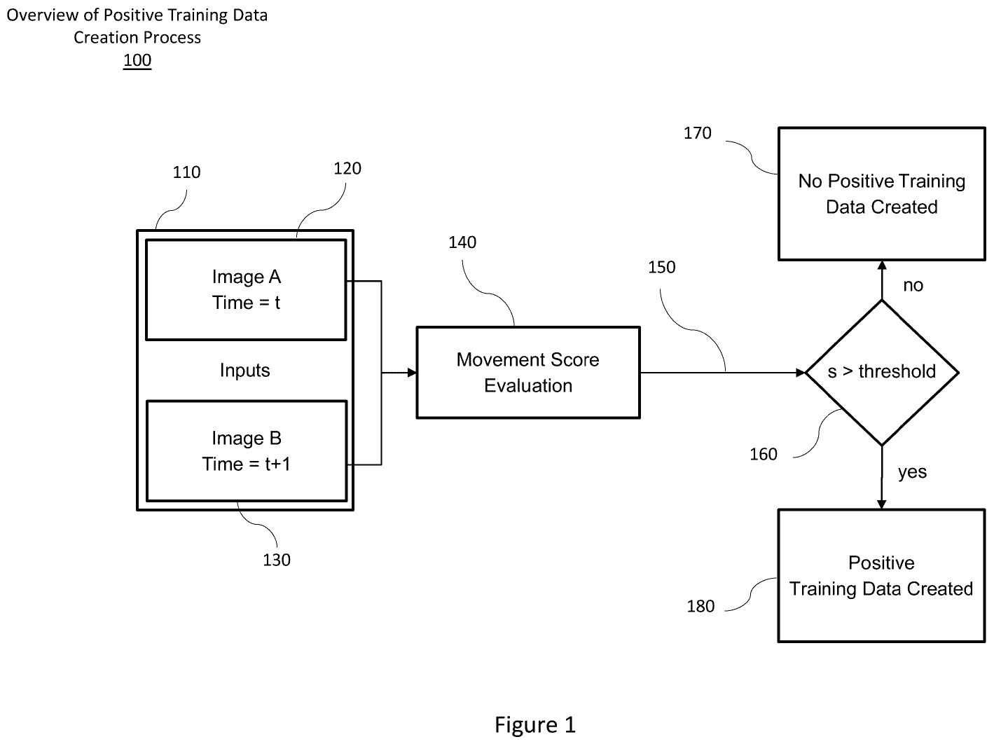

Referring to FIGS. 1 to 8, an example embodiment will now be described, and then some alternatives and further embodiments will be described.

Referring first to FIG. 1, there is shown an overview of a positive training data creation process 100 according to an embodiment, which will now be described in more detail below.

To create alerts in a security system based on movements detected in the video feeds connected to the security system, a measure of what is considered to be movements that should trigger an alarm needs to be developed. Using machine learning approaches can provide a more accurate alarm trigger but, to train a machine learning model to issue alarms when movement is detected in a video feed, substantially accurate and/or high quality training data is needed. For example, training data showing labelled images from a video feed in which sufficient movement between frames of video that would be desired to trigger an alarm needs to be generated.

In the example embodiment, a movement score is determined for two frames 120, 130 of a video feed. The video feed is divided into a plurality of paired frames 120, 130 and each paired frame 120, 130 is used as an input 130 to the process 100. A movement score evaluation 140 is performed on the two frames 120, 130 and a movement score is output 150. If the movement score s is above a threshold 160 then the two frames are output as positive training data 180. If the threshold is not reached 160, then the frames are not considered suitable training data and are not output as such 170.

In alternative embodiments, the movement score and/or data to identify the relevant frames are output in step 180 rather than, or in addition to, the frames 120, 130 themselves.

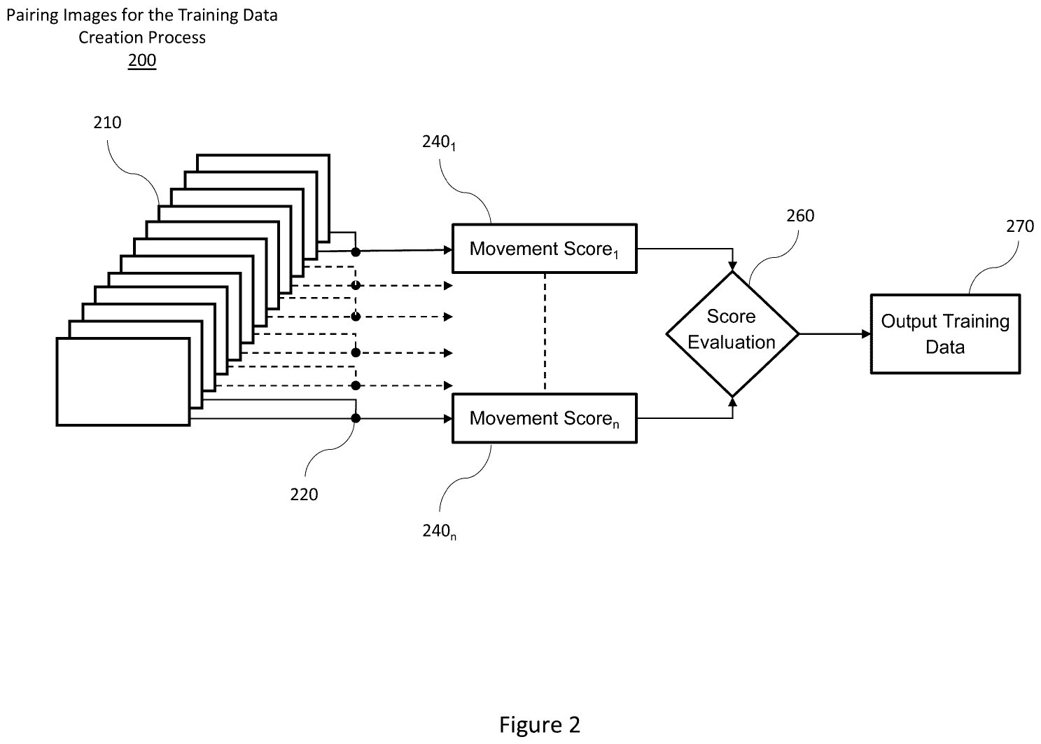

Referring now to FIG. 2, there is shown an example of pairing images for the training data creation process 200 according to an embodiment which will now be described in more detail below.

A video 210 can be divided up into a plurality of sequential frames, each of the sequential frames being paired up with at least the next sequential frame to create a plurality of paired sequential frames 220.

In other embodiments, different combinations of the frames of the video 210 can be paired up, such as frames that are not sequential but which have one or more frames in between such as every other frame or every third frame. In some embodiments multiple combinations of sequential and substantially sequential frames are possible. For example, these embodiments can be used to ignore video frames that are partially or fully occluded by objects blocking the field of view of the camera.

In some embodiments, the video 210 is encoded in such a way that decoding into individual sequential frames is required as an intermediate step to allow easy processing of the image frames of the video 210.

For each of the paired sequential frames 220, a movement score 240₁ to 240ₙ is generated. These movement scores 240₁ to 240ₙ are evaluated 260 against a predetermined threshold, the predetermined threshold set to allow the identification of movement scores showing an amount of movement that should trigger an alert or alarm in a security system should such movement be observed in security video feeds. Movement scores that exceed the predetermined threshold are then output as training data 270.

The pre-determined threshold can, in other embodiments, be dynamic and can alternatively select the paired sequential frames 220 having the top movement scores of all of the paired sequential frames 220, for example the paired sequential frames having the top 20% of movement scores can be selected as the output training data 270.

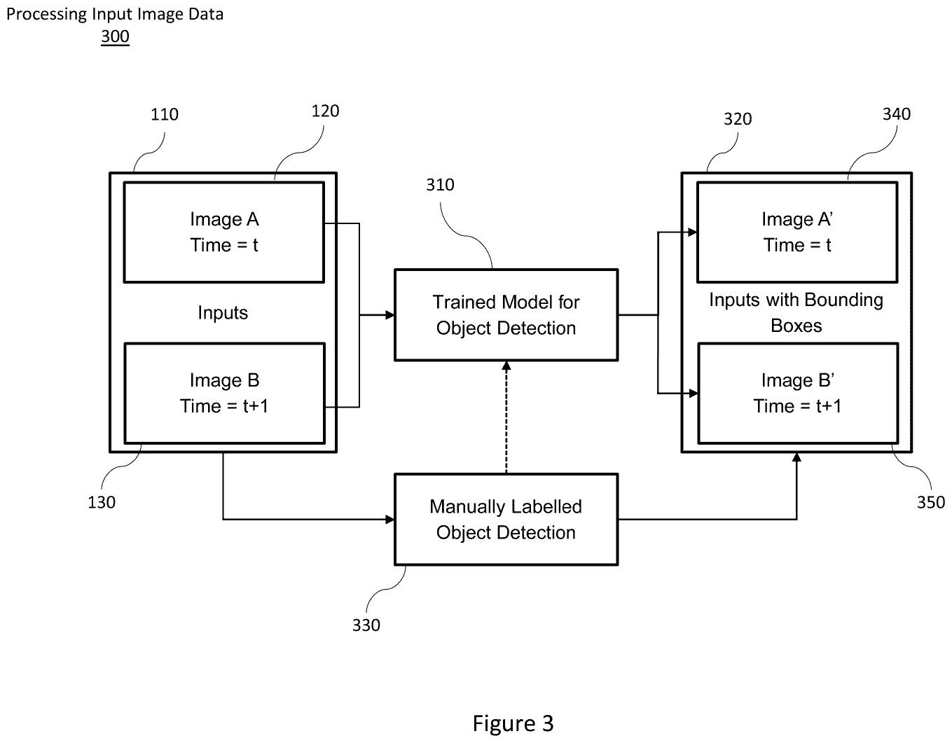

Referring now to FIG. 3, there is shown an example of processing input image data 300 according to an embodiment which will now be described below in more detail.

As described in embodiments described herein, a video is split into a plurality of component image frames and two of these frames 120, 130 are provided as inputs 110. The inputs 110 are provided to a trained model for object detection 310 which in this embodiment is a machine learned trained model, trained to detect objects in images and apply bounding boxes to these objects, and to identify common objects between images where possible. The output of the model 310 are a set of inputs with bounding boxes 320 comprising each of the original input frames with bounding boxes for the detected objects applied 340, 350.

These inputs augmented with bounding boxes 320 can then be used to determine a movement score for each pair of images.

In this example embodiment, the object detection is performed on pairs of images 120, 130 in order to only provide bounding boxes for objects detected in both images that are common to both images. In other embodiments, object detection can be performed independently for each frame in the video being considered and matching common objects between pairs of frames can be performed as a further step.

As suggested in FIG. 3, the images can be processed by manually labelling the images 330, automatically labelling the images 310 or by a combination of both. In some embodiments, manual object identification and labelling 330 can be performed to prepare the input image data. One or more humans manually identify objects of interest in each image by drawing a bounding box around an object in first frame, followed by manually drawing another box around the same object in second image frame. This allows the same objects to be tracked across the visible frame of the camera sensor, and through a sequence of image frames. The process is repeated for each of the objects of interest in the sequence and results in a set of images with labelled bounding boxes 320.

In some embodiments, automatic object identification can be performed. An object detector 310 can be used to identify and localise the objects of interest in each frame of the video/each image. The object detector processes image patches (portions of the whole image) and makes a prediction about whether it contains an object of interest—for example, if the object detector is trained or configured to identify vehicles or people, it would make prediction about whether the image patch being considered contains a vehicle or a person—depending on what the object of interest is or objects of interest are (i.e. what the object detector is configured and/or trained to detect). A bounding box can be applied around each detected/predicted object in each image/image patch/image frame.

Following detection of objects in the images/frames, and as further described in the following figures, the objects detected/identified in each frame need to be linked across images/frames. In an embodiment, linking detected/predicted/identified objects across frames/images can be performed by using the following steps:
1. Crop each pair of substantially neighbouring frames to isolate one or more patches of each image surrounding the respective one or more objects located in the images (e.g. by the detector or manually), so the N patches in frame t and the M patches in frame t+1 that correspond to the objects located in the images.
2. Pass each of the patches through an encoder to obtain fixed-length vector representations of each of the image patches to generate N vectors corresponding to the N patches and M vectors corresponding to the M patches. The encoder is a machine learning model that has been pre-trained on a visual similarity task, so it can decide whether two images look the same or not.
3. Compute the distances between each of the N vectors from frame t and each of the M vectors in frame t+1. Vectors that are close together (i.e. the distance between them is small) are more likely to look the same and thus by the same object.
4. Use a bi-partite matching algorithm so that the optimal matching occurs between the two sets. This ensures that each vector in N matches at most one vector in M and the distances between each pair of matched N and M vectors is the smallest possible.
5. Objects in each frame are now matched by the paired N and M vectors and therefore are now linked across substantially neighbouring frames.
6. The process can be repeated for frame t+1 and t+2 and upwards.

The above method associated objects across frames by considering their appearance, which as a result means that things in the images that look the same should be associated. In some embodiments, location information is also used alongside appearance information so, for example, it can be pre-determined that objects should move very far between frames so if you have a detection in the bottom left of frame t and the top right in frame t+1, this predetermination would mean that it will be assumed that these detections do not relate to the same object. Equally, if time is taken into account in this predetermination, then if there is a sufficient time interval between frames t and t+1 then it may be possible to associate the two detections as the time interval may permit an object to travel sufficient distance to move as much as is detected between frames.

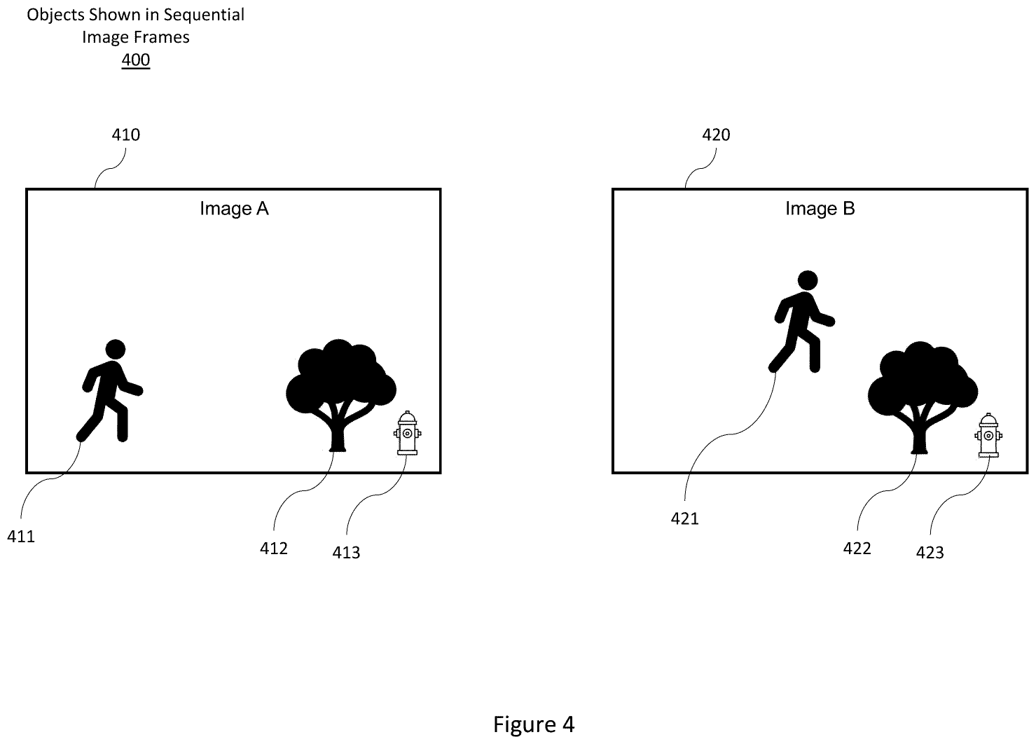

Next, referring to FIG. 4, an example of objects shown in sequential image frames 400 according to an embodiment is shown and will be described in further detail.

Shown in the figure are two sequential images 410, 420 where the first image 410 shows an image of a scene at a first time and a second image 420 shows an image of the same scene at a later time. In both images are a person 411, a tree 412 and a fire hydrant 413.

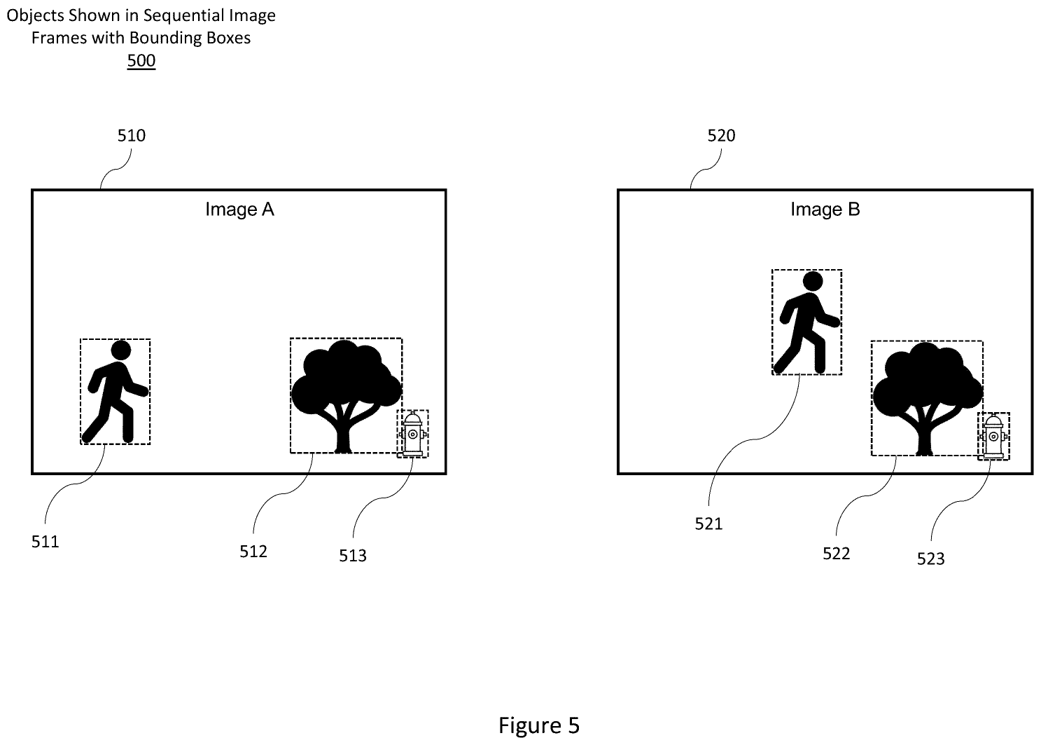

Referring now to FIG. 5, an example of objects shown in sequential image frames with bounding boxes 500 is shown and will now be described in more detail below.

The images shown are the same as in FIG. 4, but to which bounding boxes have been applied to the person 511, the tree 512 and the fire hydrant 513 in the first image 510 and then to the same objects in the second image 520, i.e. to the person 521 in a different position within the environment and to the tree 522 and fire hydrant 523 in the same positions in the environment.

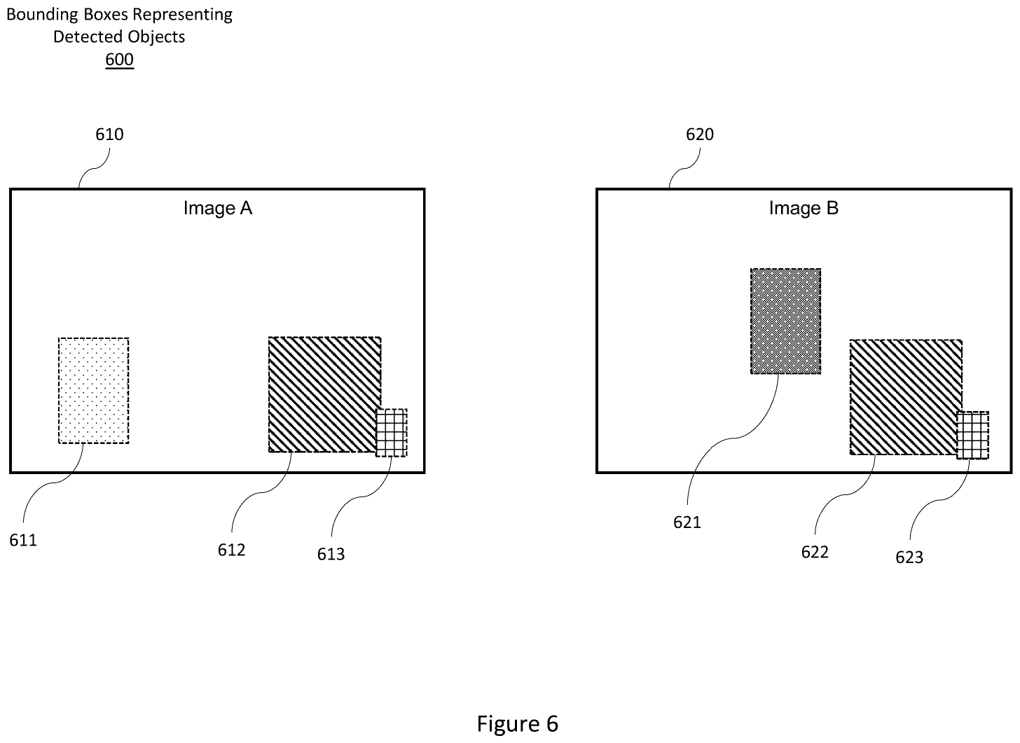

Referring now to FIG. 6, an example of just the bounding boxes representing the detected objects 600 according to an embodiment is shown and will now be described in more detail below.

The images 610, 620 can be represented purely by the bounding boxes 611, 612, 613 in the first image 610 and the bounding boxes 621, 622, 623 in the second image 620, allowing common object bounding boxes to be associated between images 610, 620 such as a moving bounding box 611, 621 and stationary bounding boxes 612, 613, 622, 623.

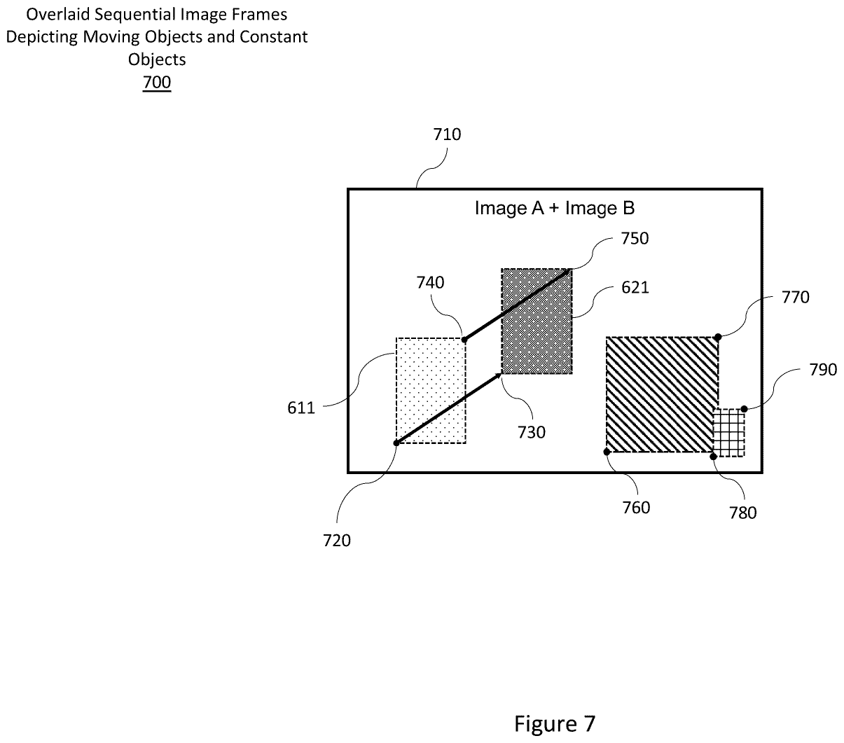

Referring now to FIG. 7, an example of overlaid sequential image frames depicting moving objects and constant objects 700 is shown and will now be described in more detail below.

The bounding boxes from the previous images shown in FIG. 6 are overlaid into a composite set 710 which shows that the top right points 740, 750 of the moving object bounding boxes indicate movement between the first bounding box 611 and the second bounding box 621 and that the bottom left points 720, 730 of the moving object bounding boxes indicate movement between the first bounding box 611 and the second bounding box 621 and the movement of each corner can be calculated (both in length and in direction). In comparison, the two objects that remained constant, i.e. stationary, have bounding boxes with top right points 770, 790 and bottom left points 760, 780 that remain in the same place in both images.

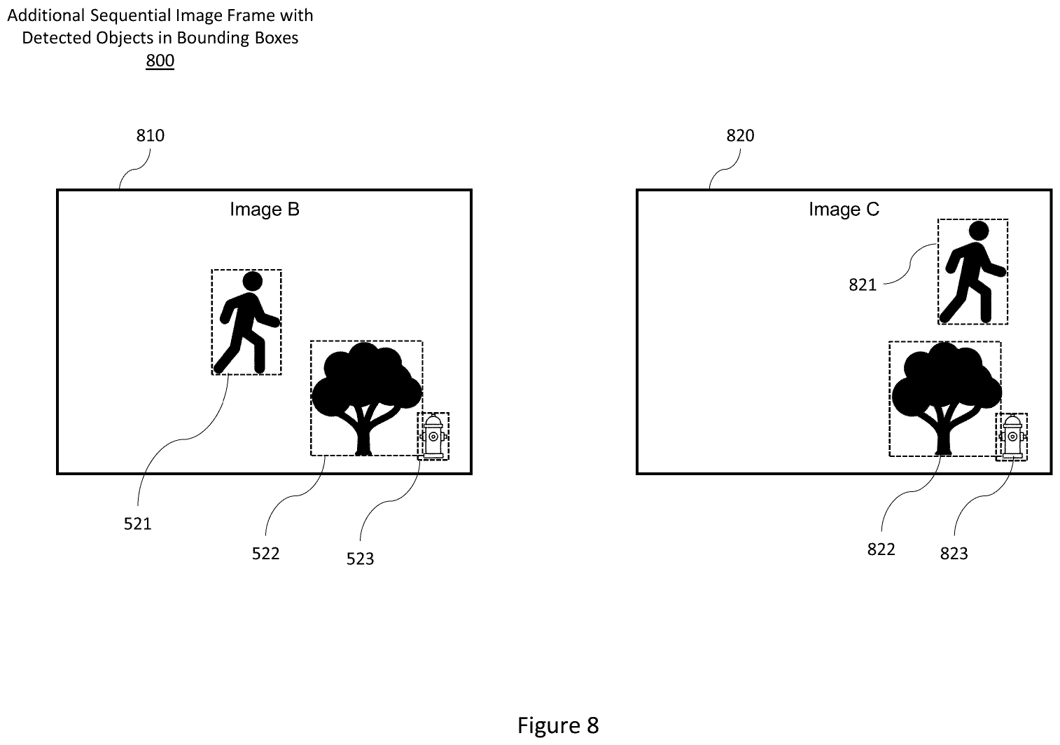

Referring now to FIG. 8, an example of an additional sequential image frame with detected objects in bounding boxes 800 according to an embodiment is shown and will now be described in more detail.

A further image frame 820 is shown in a pair of image frames 810, 820 that sequentially follows the earlier image frames in the video from which all of the fames are extracted and which are shown in FIGS. 4 to 7, including one of the earlier image frames 420, 520, 620, 810 in the pair of image frames 810, 820.

Again, bounding boxes 521, 522, 523, 821, 822, 823 are applied to objects detected in each image 810, 820.

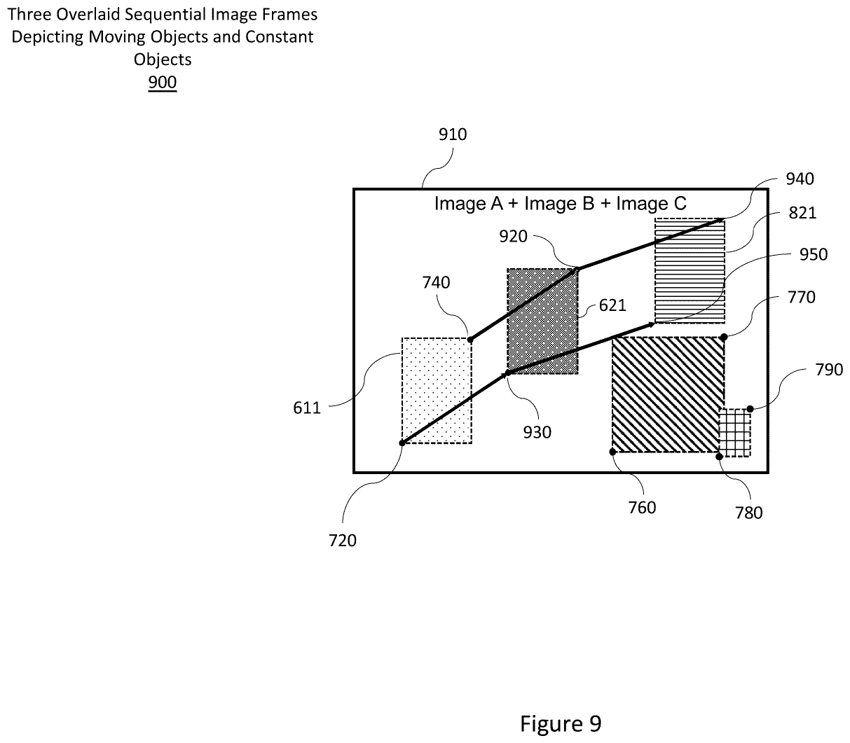

Referring now to FIG. 9, an example of three overlaid sequential image frames depicting moving objects and constant objects 900 according to an embodiment is shown and will now be described in more detail.

In this example, common moving objects 611, 621, 821 between the frames can have their movement between frames assessed by tracking the movement between the top right corners of the bounding box 740, 920, 940 in each frame corresponding to the common object and the movement between the bottom left corners of the bounding box 720, 930, 950 in each frame corresponding to the common object.

Similarly, the top right corners 770, 790 of the bounding box of stationary/constant objects in each frame and the bottom left corners 760, 780 of the bounding box of stationary/constant objects in each frame remain in the same place within each frame thus no movement is shown between these corners.

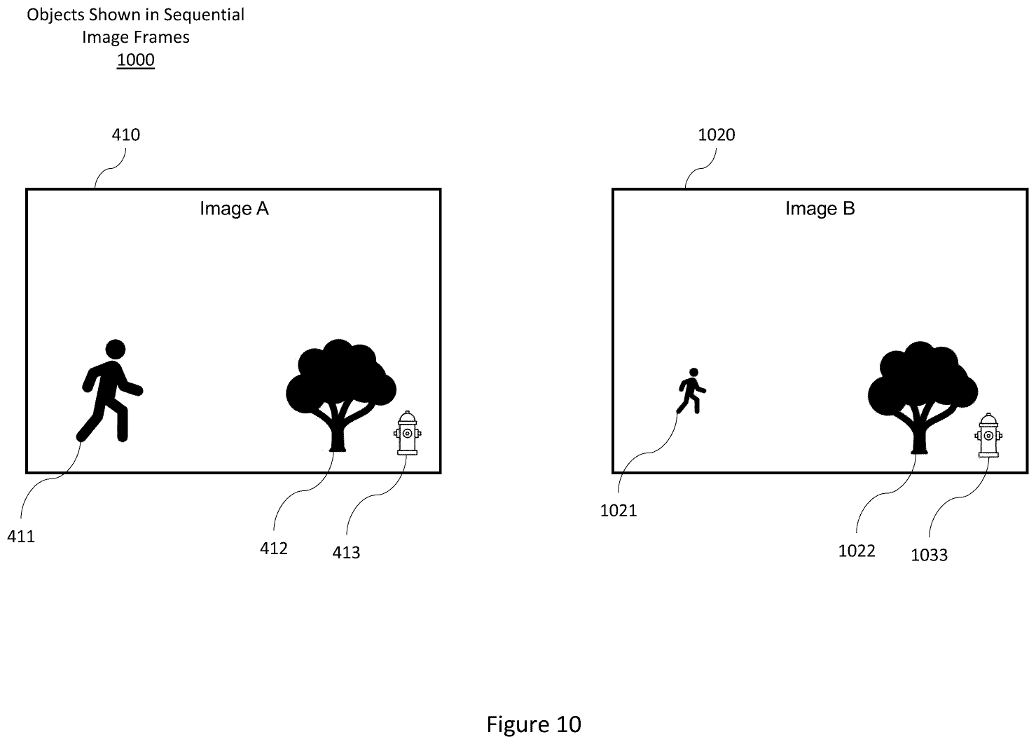

Referring now to FIG. 10, another example of objects shown in sequential frames 1000 is shown according to an embodiment which will now be described in further detail.

Here, between two frames 410, 1020, one of the objects moves from being close to the image sensor to being further away from the image sensor, specifically the person 411 in the first frame 410 is shown nearer to the image sensor and then shown as the same person 1021 further away from the image sensor in the second frame 1020.

As with the other examples described above, the other objects 412, 413, 1022, 1033 remain in the same place within each frame 410, 1020 as these are stationary objects.

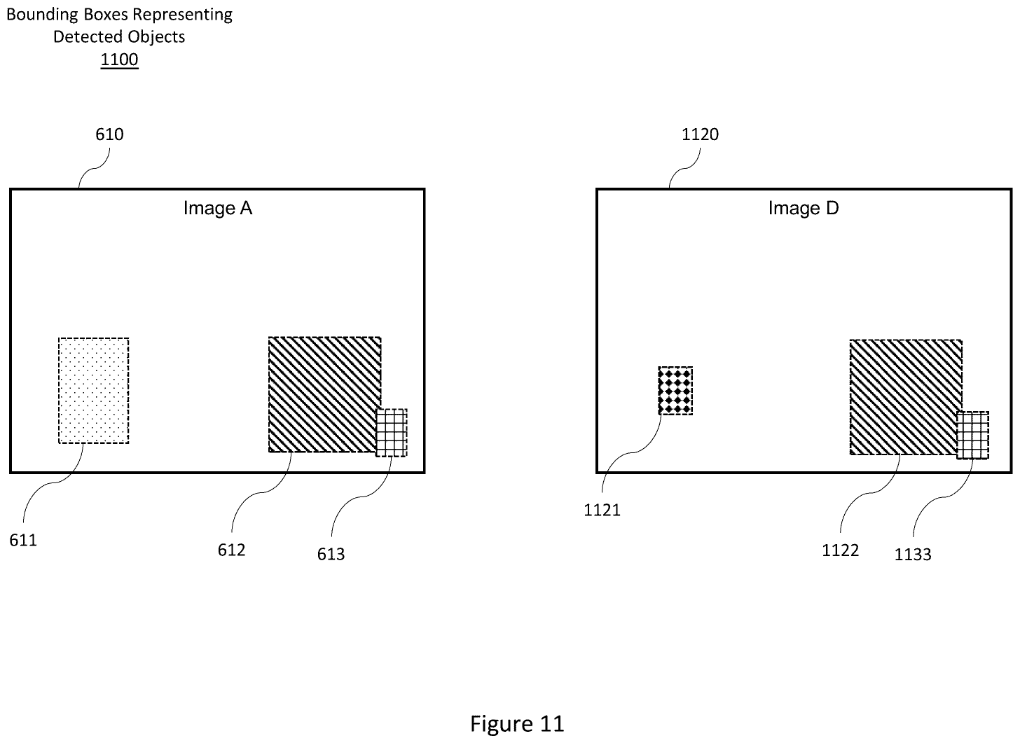

Referring now to FIG. 11, bounding boxes representing the detected objects 1100 shown in FIG. 10 are shown and will now be described in more detail.

In the first frame 610, the moving object 611 and the two stationary objects 612, 613 are represented by bounding boxes covering the regions of the frame in which the objects were detected in the source image data. In the second frame 1120, the moving object 1121 is represented by a bounding box having a smaller area, indicating that the object has moved further away from the image sensor capturing the image, while the two stationary objects 1122, 1133 remain in the same positions and having the same area/size as the corresponding bounding boxes in the first frame 610.

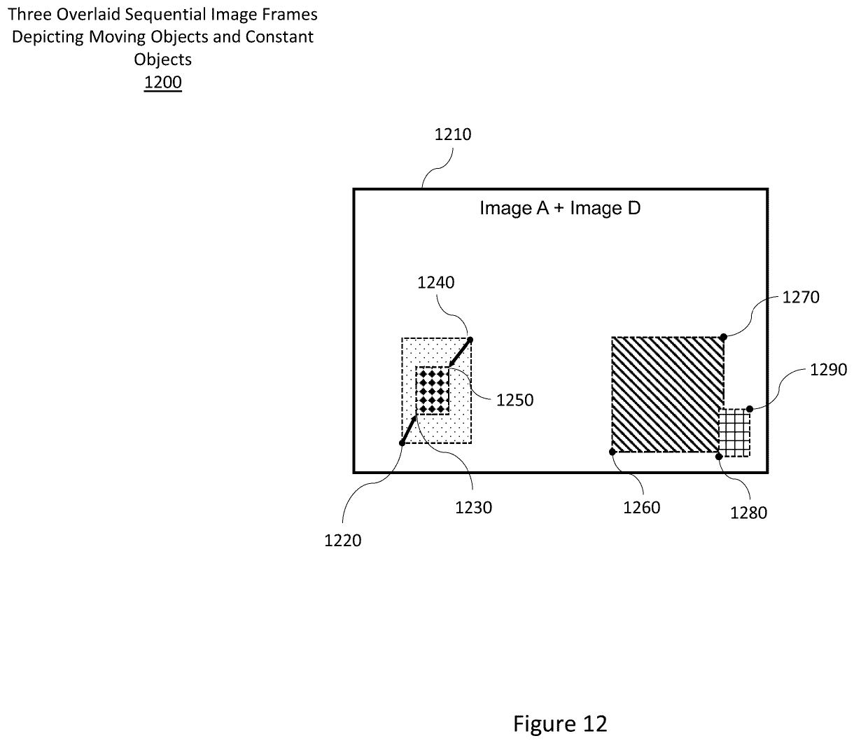

Referring now to FIG. 12, there is shown overlaid sequential image frames depicting moving objects and constant objects 1200 using the two frames shown in FIGS. 10 and 11, which will now be described in more detail.

The bounding boxes for each frame are overlaid 1210 and the top right and bottom left corners of the bounding boxes between frames are located and the distance between these respective corners between bounding boxes in each frame are determined. In the example, the moving object has movement determined for these corners 1220, 1230, 1240, 1250 between bounding boxes while the stationary objects have no movement indicated by the positions of the respective corners 1260, 1270, 1280, 1290 remaining in the same position when comparing the bounding boxes from the two frames.

Machine learning is the field of study where a computer or computers learn to perform classes of tasks using the feedback generated from the experience or data gathered that the machine learning process acquires during computer performance of those tasks.

Typically, machine learning can be broadly classed as using either supervised or unsupervised approaches, although there are particular approaches such as reinforcement learning and semi-supervised learning which have special rules, techniques and/or approaches.

Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets.

Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled. For unsupervised machine learning, there is a range of possible applications such as, for example, the application of computer vision techniques to image processing or video enhancement.

Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships. When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

Machine learning may be performed through the use of one or more of: a non-linear hierarchical algorithm; neural network; convolutional neural network; recurrent neural network; long short-term memory network; multi-dimensional convolutional network; a memory network; fully convolutional network or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Developing a machine learning system typically consists of two stages: (1) training and (2) production.

During the training the parameters of the machine learning model are iteratively changed to optimise a particular learning objective, known as the objective function or the loss.

Once the model is trained, it can be used in production, where the model takes in an input and produces an output using the trained parameters.

During the training stage of neural networks, verified inputs are provided, and hence it is possible to compare the neural network's calculated output to then the correct the network is need be. An error term or loss function for each node in neural network can be established, and the weights adjusted, so that future outputs are closer to an expected result. Backpropagation techniques can also be used in the training schedule for the or each neural network.

The model can be trained using backpropagation and forward pass through the network. The loss function is an objective that can be minimised, it is a measurement between the target value and the model's output.

The cross-entropy loss may be used. The cross-entropy loss is defined as

$${L}_{CE} = - {\sum }_{c = 1}^{C} y * log ( s )$$

where C is the number of classes, y∈{0,1} is the binary indicator for class c, and s is the score for class C.

In the multitask learning setting, the loss will consist of multiple parts. A loss term for each task.

L(x)=λ₁L₁+λ₂L₂

where L₁, L₂ are the loss terms for two different tasks and λ₁, λ₂ are weighting terms.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

1. A computer-implemented method of generating training data for one or more computer models, the method comprising:
receiving a plurality of image data, wherein the image data comprises two or more sequential images wherein the image data comprises one or more objects determined in each of the plurality of images and wherein the image data comprises a bounding box identifying each of the one or more objects in each of the plurality of images and wherein the image data comprises one or more common objects identified in two or more sequential images;
determining a correlation between the identified one or more common objects detected in two or more sequential images using the bounding boxes for each of the one or more common objects;
generating a score indicating movement of the identified one or more common objects detected in two or more sequential images based on the determined correlation; and
outputting the score associated to each of the identified one or more common objects.

2. The method of claim 1 wherein, generating the bounding box for each of the one or more objects comprises using one or more trained computer models.

3. The method of claim 1 wherein, the bounding box for each of the one or more objects comprises manual labelling by one or more human users.

4. The method of claim 1 further comprising determining at least two sequential images based on metadata associated with the image data.

5. The method of claim 4 wherein, the metadata associated with the image data comprises timestamp data.

6. The method of claim 1 further comprising determining at least two sequential images based on similarities of determined one or more objects in at least two sequential images.

7. The method of claim 1 wherein determining a correlation between the identified one or more common objects comprises comparing at least two corners of a bounding box of one or more common objects in a first image to at least two corresponding corners of a bounding box for the same one or more common objects in a sequential image.

8. The method claim 1 wherein determining a correlation between the identified one or more common objects comprises determining whether the bounding boxes for the one or more common objects in two or more sequential images have deviated in size.

9. The method of claim 1 wherein determining a correlation between the identified one or more common objects comprises determining whether the bounding boxes for the one or more common objects in two or more sequential images have deviated in location.

10. The method of claim 9 wherein the deviation in location corresponds to a co-ordinate gride of the image data or based on an XY axis of the image data.

11. The method of claim 10 wherein, the deviation comprises a predetermined threshold of pixels.

12. The method of claim 1 wherein generating a score is based on the deviation between at least two corners of a bounding box of one or more common objects in a first image and at least two corresponding corners of a bounding box for the same one or more common objects in a sequential image.

13. The method of claim 1 wherein generating a score is based on the size of the bounding box relative to the image frame.

14. The method of claim 1 wherein generating a score is based on an average deviation of at least two corners of a bounding box of one or more common objects in a first image and at least two corresponding corners of a bounding box for the same one or more common objects in a sequential image.

15. The method of claim 14 wherein the average deviation comprises generating and comparing a deviation in the diagonal length of a bounding box of one or more common objects in the first image and the diagonal length of a bounding box of one or more common objects in the sequential image.

16. The method of claim 1 wherein outputting the score comprises a predetermined threshold.

17. The method of claim 1 further comprising outputting one or more pairs of bounding boxes for one or more common objects.

18. (canceled)

19. (canceled)

20. The method of claim 1 wherein the one or more common objects in two or more sequential images are identified by any or any combination of: manually identifying common objects between each of the images; matching objected detected in multiple images and applying a link between detected objects in different images.

21. A computer program comprising instructions which, when the program is executed by a computer, cause the computer to carry out the method of claim 1.

22. A computer-readable medium comprising instructions which, when executed by a computer, cause the computer to carry out the method of claim 1.
